(19) United States
(12) Patent Application Publication
(10) Pub. No.: US 2010/0319251 A1
(43) Pub. Date: Dec. 23, 2010

(54) FALLOW-FREE AEROBIC GARDEN

(76) Inventor: Jui-Chang Su, Ping Tung Hsien (TW)

Correspondence Address: Jui-Chang Su, 235 Chung - Ho Box 8-24, Taipei,, TW

(21) Appl. No.: 12/488,602

(22) Filed: Jun. 22, 2009

(51) Int. Cl. A01G 9/02; A01G 25/00; A01G 13/08

(52) U.S. Cl. 47/79

(57) ABSTRACT

A fallow-free aerobic garden having sufficient water and oxygen supply can be applied to an artificial garden in the air and a conventional garden on the ground. A gravel layer is laid as a bottom layer of the garden. An air tube is arranged in the gravel layer. A net layer is arranged onto the gravel layer. A cultivation soil is laid onto the net layer. A water tube is arranged in the cultivation soil. Net covers are wrapped around each air vent and water outlet formed to the air tube and the water tube. Air is supplied by the air tube under a predetermined air pressure and a predetermined volume of water is supplied by the water tube under a predetermined water pressure so that an appropriate environment for growing fruits and vegetables is formed to the artificial garden.

### FIELD OF THE INVENTION

The present invention relates to garden, and particular to a fallow-free aerobic garden having sufficient water and oxygen supply.

### BACKGROUND OF THE INVENTION

Vegetables and fruits are usually planted by farmers. Except the conventional cultivation, hydroponics is also praised for the effective crop and the natural food without pollutions and pesticides.

In the development and technique of the cultivation of vegetables and fruits, a hygiene and safe cultivation is the most important goal for people. Inferior crops with residual pesticides supplied by abominable supplier are damaging the health of the public.

Therefore, a concept of home cultivation is gradually accepted by people. Crops are planted at places in the house such as the balcony or the roof. However, the cultivations are usually abandoned because of the constantly caring and watering which is an encumbrance to the planter.

Moreover, sun light, air, and water are the three essential conditions for growing plants, and the quality of the crops is also related. Opposite to sun light and water, air are not emphasized within prior technique.

### SUMMARY OF THE PRESENT INVENTION

Accordingly, the primary object of the present invention is to provide a fallow-free aerobic garden which can be applied to a conventional ground garden and an artificial garden in the air.

A gravel layer is laid as a bottom layer of the garden. An air tube is arranged in the gravel layer. A net layer is arranged onto the gravel layer. A cultivation soil is laid onto the net layer. A water tube is arranged in the cultivation soil. Net covers are wrapped around each air vent and water outlet formed to the air tube and the water tube.

Air is supplied by the air tube under a predetermined air pressure and a predetermined volume of water is supplied by the water tube under a predetermined water pressure so that an appropriate environment for growing fruits and vegetables is formed to the artificial garden. Moreover, while seeding after a harvest, residual gas and methane in the cultivation soil remained from the last crop can be purged by high pressure air supplied by the air tube so that the artificial garden can be continuously planted without fallows.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

A fallow-free aerobic garden according to the present invention can be applied to an artificial garden in the air and a conventional garden on the ground. The artificial garden on the air using a container with a predetermined capacity is shown in FIG. 1, and the application in the conventional garden on the ground is shown in FIG. 4.

Referring to FIGS. 1 to 3, embodiments of the present invention applied to the artificial garden in the air are illustrated. The artificial garden is a container 1 with a predetermined capacity. A drain hole 11 is formed to a bottom of the container 1 for draining out water to a water tank 10. A sand layer 14 is laid on the bottom inside the container 1. A gravel layer 12 is laid onto the sand layer 14. An air tube 2 is arranged in the gravel layer 12. A net layer 3 is arranged onto the gravel layer 12. A cultivation soil 13 is laid onto the net layer 3. A water tube 4 is arranged in the cultivation soil 13.

At least one air vent 21 is arranged to the air tube 2, and a net cover 22 is wrapped around the at least one air vent 21. An end of the air tube 2 is connected to an air pump 20. At least one water outlet 41 is arranged to the water tube 4, and a net cover 42 is wrapped around the at least one water outlet 42. An end of the water tube 4 is connected to a water pump 40.

Air is supplied by the air tube under a predetermined air pressure and a predetermined volume of water is supplied by the water tube under a predetermined water pressure so that an appropriate environment for growing fruits and vegetables is formed to the artificial garden. Moreover, while seeding after a harvest, residual gas and methane in the cultivation soil remained from the last crop can be purged by high pressure air supplied by the air tube so that the artificial garden can be continuously planted without fallows.

Referring to FIG. 4, an embodiment of the present invention applied in a conventional ground garden is illustrated. The gravel layer 12 is laid as a bottom layer of a conventional garden of a predetermined area. The air tube 2 is arranged in the gravel layer 12. The net layer 3 is arranged onto the gravel layer 12. The cultivation soil 13 is laid onto the net layer 3. The water tube 4 is arranged in the cultivation soil 13.

At least one air vent 21 is arranged to the air tube 2, and the net cover 22 is wrapped around the at least one air vent 21. The end of the air tube 2 is connected to the air pump 20. At least one water outlet 41 is arranged to the water tube 4, and the net cover 42 is wrapped around the at least one water outlet 42. The end of the water tube 4 is connected to the water pump 40.

Air is supplied by the air tube under a predetermined air pressure and a predetermined volume of water is supplied by the water tube under a predetermined water pressure so that an appropriate environment for growing fruits and vegetables is formed to the artificial garden on the ground. Moreover, while seeding after a harvest, residual gas and methane in the cultivation soil remained from the last crop can be purged by high pressure air supplied by the air tube so that the artificial garden can be continuously planted without fallows.

Therefore, the fallow-free aerobic garden has lower cost and high efficiency. Fruits and vegetables are grown fast in the garden and with outstanding quality so that it can be widely applied to the artificial garden on a balcony, garden, open space, and roof of a house and also the conventional garden on the ground.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

### BRIEF DESCRIPTION OF THE DRAWINGS

FIG. 1 is a cross-section view showing an embodiment of the present invention.

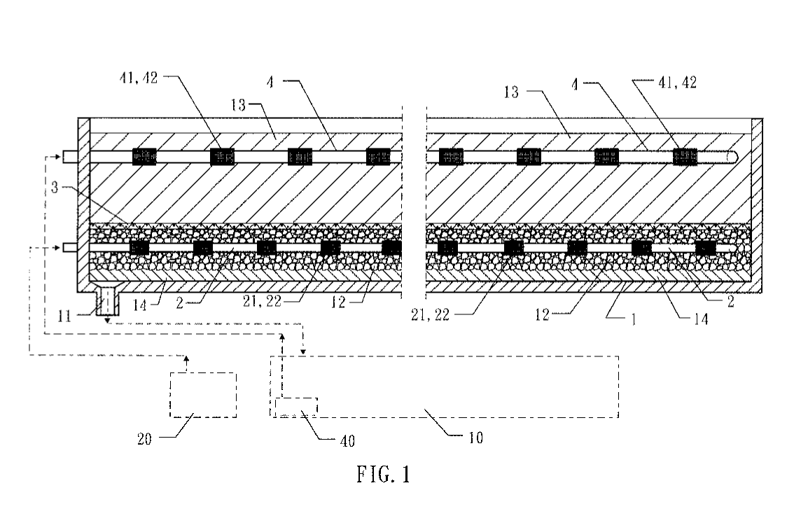

FIG. 2 is a cross-section view showing a multiple layers embodiment of the present invention.

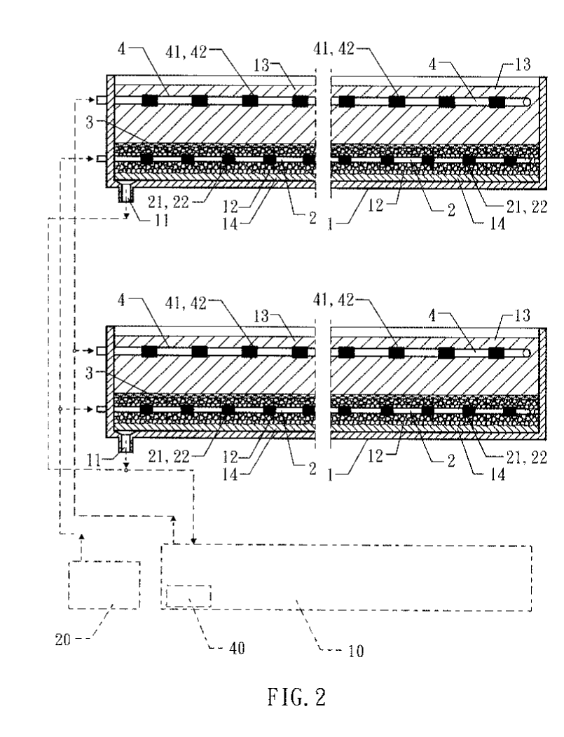

FIG. 3 is a cross-section view showing a cultivation of the present invention.

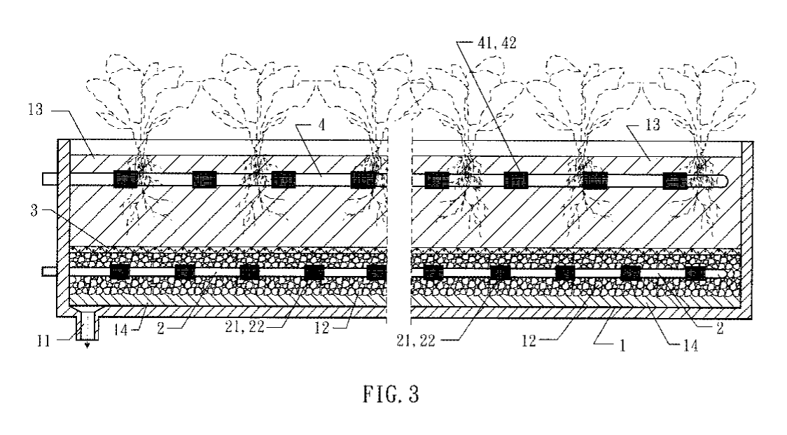

FIG. 4 is a cross-section view showing an embodiment of the present invention applied to a conventional ground garden.

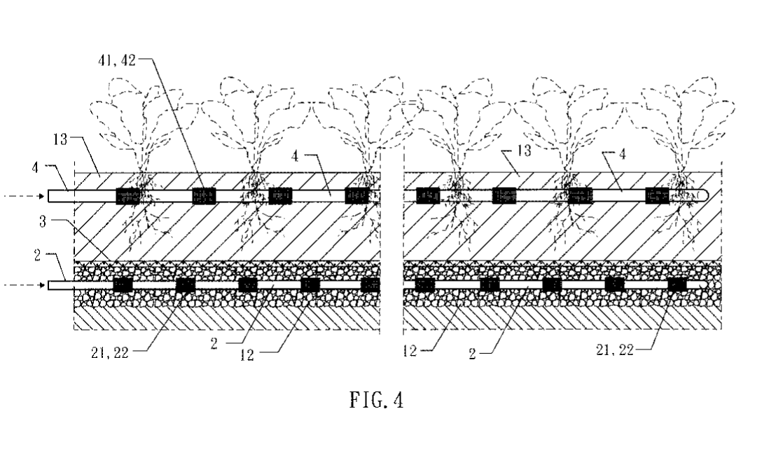

What is claimed is:

1. A fallow-free aerobic garden comprising:
a container with a predetermined capacity as a garden; a drain hole being formed to a bottom of the container; a sand layer being laid on the bottom of the container; a gravel layer being laid onto the sand layer; a net layer being arranged onto the gravel layer; a cultivation soil being laid onto the net layer; an air tube being arranged in the gravel layer; at least one air vent being arranged to the air tube, and a net cover being wrapped around the at least one air vent; a water tube being arranged in the cultivation soil; at least one water outlet being arranged to the water tube, and a net cover being wrapped around the at least one water outlet.

2. The fallow-free aerobic garden as claimed in claim 1, wherein an end of the air tube is connected to an air pump.

3. The fallow-free continuous aerobic garden as claimed in claim 1, wherein an end of the water tube is connected to a water pump.
a sand layer being laid as a bottom layer of the garden; a gravel layer being laid onto the sand layer; a net layer being arranged onto the gravel layer; a cultivation soil being laid onto the net layer; an air tube being arranged in the gravel layer; at least one air vent being arranged to the air tube, and a net cover being wrapped around the at least one air vent; a water tube being arranged in the cultivation soil; at least one water outlet being arranged to the water tube, and a net cover being wrapped around the at least one water outlet.

5. The fallow-free aerobic garden as claimed in claim 4, wherein an end of the air tube is connected to an air pump.

6. The fallow-free continuous aerobic garden as claimed in claim 4, wherein an end of the water tube is connected to a water pump.
